(19) United States
(12) Patent Application Publication
(10) Pub. No.: US 2009/0322458 A1
(43) Pub. Date: Dec. 31, 2009

(54) MAGNETIC COMPONENT

(76) Inventors: Cheng-Chang Lee, Taoyuan Hsien (TW); Deng-Yan Zhou, Taoyuan Hsien (TW); Zeng-Yi Lu, Taoyuan Hsien (TW); Ming-Hsien Lin, Taoyuan Hsien (TW); Heng-Chung Chang, Taoyuan Hsien (TW); Wei Chen, Taoyuan Hsien (TW); Tai-Kang Shing, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/330,855

(22) Filed: Dec. 9, 2008

(30) Foreign Application Priority Data
Jun. 30, 2008 (TW) 097124509

(51) Int. Cl. H01F 5/00

(52) U.S. Cl. 335/299

(57) ABSTRACT

A magnetic component includes at least one coil and a permeable structure. The coil is formed by a radially wound wire, and the thickness of the wire is various according to the distance from a portion of the wire to the center axis of the coil. The coil is covered by the permeable structure.

### CROSS REFERENCE TO RELATED APPLICATIONS

This Non-provisional application claims priority under 35 U.S.C. §119(a) on Patent Application No(s). 097124509 filed in Taiwan, Republic of China on Jun. 30, 2008, the entire contents of which are hereby incorporated by reference.

### BACKGROUND OF THE INVENTION

1. Field of Invention

The present invention relates to a magnetic component and, in particular, to a magnetic component with the high-quality factor and high performance.

2. Related Art

The present magnetic component has been widely applied to the inductor, transformer or noise filter in the power converter. The loss of the magnetic component is mainly caused by the coil loss and the core loss. Regarding to the power inductor or transformer, the resistance loss power caused by the current flowing through the coil and the resistance of the coil have the relationship of direct proportion.

Since the thickness, the width and the gap between two adjacent circles of the conventional coil are all constant, the prior art can decrease the resistance of the coil only by utilizing the wire with a larger diameter. This will cause the increase of the coil size. Thus, the conventional coil has become a problem for the present minimized devices.

### SUMMARY OF THE INVENTION

In view of the foregoing problem, the present invention is to provide a magnetic component for the inductor, transformer or filter with the high-quality factor and high performance.

The present is also to provide a magnetic component for providing proper quality factor and performance according to the actual need.

To achieve the above, the present invention discloses a magnetic component including at least one coil and a permeable structure. The coil is formed by a radially wound wire, and the thickness of the wire is various according to the distance from a portion of the wire to the center axis of the coil. The permeable structure covers the coil.

In the above-mentioned magnetic component of the present invention, the thickness of the wire is gradually increased or decreased from the inner circle to the outer circle of the wire.

In addition, the present invention also discloses a magnetic component including at least a coil and a permeable structure. The coil is formed by a radially wound wire, and at least two circles of the wire of the coil have different thicknesses or widths, or at least two gaps between adjacent two circles of the wire of the coil have different distances. The permeable structure covers the coil.

The thicknesses of the inner circle and the outer circle of the wire are different from that of the middle portion of the wire.

In the above-mentioned magnetic component of the present invention, the thickness of the wire is gradually increased and then gradually decreased from the inner circle to the outer circle of the wire, or is gradually decreased and then gradually increased from the inner circle to the outer circle of the wire.

In addition, the widths of the inner circle and the outer circle of the wire are different from the width of the middle portion of the wire.

In the above-mentioned magnetic component of the present invention, the width of the wire is gradually increased and then gradually decreased from the inner circle to the outer circle of the wire, or is gradually decreased and then gradually increased from the inner circle to the outer circle of the wire.

In addition, the thickness of the wire is various depending on the distance from a portion of the wire to the center axis of the coil. The thickness of the wire can be gradually increased and then gradually decreased from the inner circle to the outer circle of the wire, or can be gradually decreased and then gradually increased from the inner circle to the outer circle of the wire. Besides, the thicknesses of the inner circle and the outer circle of the wire can be different from the thickness of the middle portion of the wire. The thickness of the wire can be gradually increased and then gradually decreased from the inner circle to the outer circle of the wire, or can be gradually decreased and then gradually increased from the inner circle to the outer circle of the wire.

In addition, the gap between adjacent two inner circles of the wire and the gap between adjacent two outer circles of the wire are different from the gap between middle portions of the wire.

In the above-mentioned magnetic component of the present invention, the gap of the adjacent circles of the wire is gradually increased and then gradually decreased from the inner circle to the outer circle of the wire, or is gradually decreased and then gradually increased from the inner circle to the outer circle of the wire. In addition, the widths of the inner circle and the outer circle of the wire are different from the width of the middle portion of the wire. The thickness of the wire can be various depending on the distance from a portion of the wire to the center axis of the coil. Moreover, the thicknesses of the inner circle and the outer circle of the wire are different from the thickness of the middle portion of the wire.

In the above-mentioned magnetic component of the present invention, the permeable structure includes Ni—Zn ferrite, Mn—Zn ferrite or a polymer containing a magnetic material.

The above-mentioned magnetic component of the present invention can be formed by directly disposing the coil in the permeable structure or a permeable material. Alternatively, the magnetic component can be formed by the semiconductor manufacturing process.

In addition, the permeable structure can be composed of a first permeable body and a second permeable body, and an adhesive layer is disposed between the first permeable body and the second permeable body. The adhesive layer includes epoxy, polyamide or an adhesive material containing magnetic particles. The above-mentioned first permeable body and second permeable body can be connected with each other by welding or adhering.

In the magnetic component of the present invention, the quality factor and the coil resistance loss thereof can be easily improved by gradually increasing or decreasing the thickness of the coil, gradually increasing and then gradually decreasing the width of the coil, gradually decreasing and then gradually increasing the width of the coil, gradually increasing and then gradually decreasing the gap between adjacent two circles of the coil, or gradually decreasing and then gradually increasing the gap between adjacent two circles of the coil. Thus, the performance of the magnetic component of the present invention can be enhanced. Furthermore, the quality factor of the magnetic component can be adjusted to a proper status by the combination of the above-mentioned embodiments, so that the performance of the magnetic component can reach the optimum.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a sectional view of a magnetic component according to a preferred embodiment of the present invention;

FIG. 1B is a sectional view of another magnetic component according to the preferred embodiment of the present invention;

FIG. 1C is a sectional view of another magnetic component according to the preferred embodiment of the present invention;

FIG. 2A is a sectional view of a coil according to an example of the present invention;

FIG. 2B is a sectional view of the coil according to another example of the present invention;

FIG. 2C is a sectional view of the coil according to another example of the present invention;

FIG. 3A is a sectional view of a magnetic component according to another preferred embodiment of the present invention;

FIG. 3B is a sectional view of another magnetic component according to another preferred embodiment of the present invention; and

FIG. 4 is a partial top view of a coil according to an example of the present invention.

### DETAILED DESCRIPTION OF THE INVENTION

The present invention will be apparent from the following detailed description, which proceeds with reference to the accompanying drawings, wherein the same references relate to the same elements.

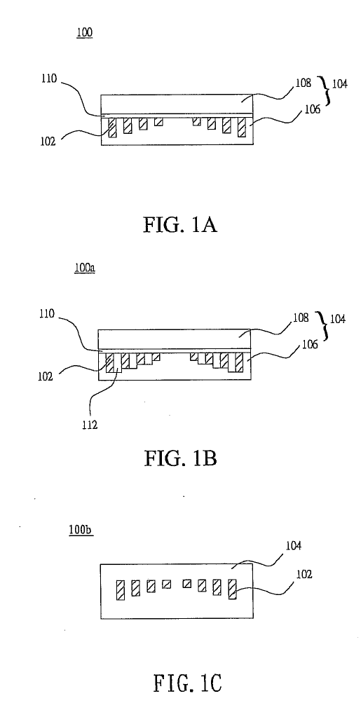

FIG. 1A is a sectional view of a magnetic component 100 according to a preferred embodiment of the present invention. The magnetic component 100 includes at least one coil 102 and a permeable structure 104. The magnetic component 100 can be an inductor, a transformer, a common mode noise filter or a differential mode noise filter. In addition, the magnetic component can be applied to a DC/DC converter or a radio frequency (RF) module.

The coil 102 is formed by a radially wound wire, and the thickness of an inner circle of the wire near a center axis of the coil 102 is different from that of an outer circle of the wire near a surface of the coil 102. More specifically, the thickness of the wire is various depending on the distance from a portion of the wire to the center axis of the coil 102. For example, the thickness of the inner circle of the coil 102 is smaller than that of the outer circle thereof. In this case, the thickness of the wire can be gradually increased from the inner circle to the outer circle. When the thickness of the inner circle of the coil 102 is smaller than that of the outer circle thereof, the resistance of the outer circle is smaller than that of the inner circle. Thus, the power loss of the outer circles can be reduced when the current flows through the coil 102. Cooperating with the magnetic flux-density distribution of the coil 102, both the direct current loss and alternating current loss of the coil 102 can be greatly decreased without increasing the volume of the magnetic component 100. Accordingly, the quality factor and performance of the magnetic component can be greatly improved.

The above-mentioned magnetic component 100 can be formed by directly disposing a coil, which is manufactured by winding a wire with non-uniform thickness, in the permeable structure or a permeable material. Alternatively, the magnetic component 100 can be formed by the semiconductor manufacturing process, such as forming a metal layer on a permeable structure 106, which has a pattern corresponding to the thickness of the coil, so as to form the coil 102. Then, another permeable structure 108 is disposed over the permeable structure 106 so as to form the permeable structure 104 for covering the coil 102. In addition, an adhesive layer 110 can be disposed between the permeable structures 106 and 108 depending on the actual need, so that the permeable structures 106 and 108 can be firmly connected. Alternatively, the permeable structure 104 can be formed by the following steps. First, two blanks of the permeable structures 106 and 108 can be formed by pre-sintering. Then, the blanks of the permeable structures 106 and 108 are adhered and then sintered so as to form the permeable structure 104. Moreover, as shown in FIG. 1B, an insulating layer 112 can be formed between adjacent two circles of the wire depending on the actual need. Another embodiment is shown in FIG. 1C, where solid permeable structure 104 encloses the coil 102. The device can be fabricated by multi-layer imprinting process an sintering together.

The permeable structure 104 can include Ni—Zn ferrite, Mn—Zn ferrite or a polymer comprising a magnetic material. The adhesive layer 110 can include epoxy, polyamide or an adhesive material containing magnetic particles.

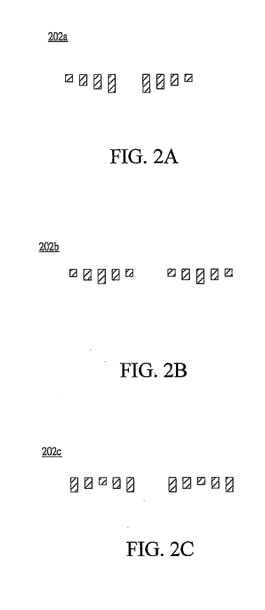

In addition, the thickness of the wire can be various according to the actual need. As shown in FIG. 2A, the inner circle of the coil 202a has a thickness thicker than the outer circle thereof. As shown in FIG. 2B, the thicknesses of the inner circle and outer circle of the coil 202b are smaller than that of the middle portion thereof. As shown in FIG. 2C, the thicknesses of the inner circle and outer circle of the coil 202c are greater than that of the middle portion thereof. In other words, the thickness of the wire can be gradually decreased from the inner circle to the outer circle of the wire. Alternatively, the thickness of the wire can be gradually increased and then gradually decreased from the inner circle to the outer circle of the wire, or is gradually decreased and then gradually increased from the inner circle to the outer circle of the wire. In the above-mentioned various aspects, the thicknesses of adjacent circles of the wire can be the same or different.

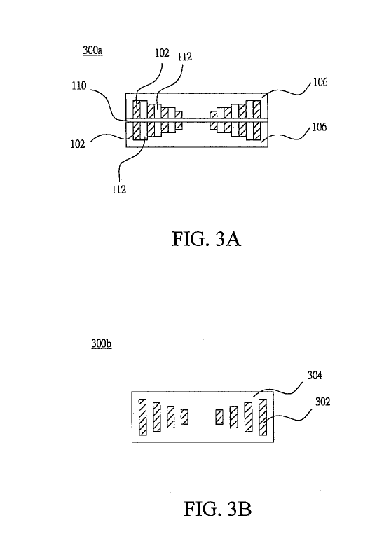

With reference to FIG. 3A, the magnetic component 300a includes two permeable structures 106, which are connected to each other. Each of the permeable structures 106 covers a coil 102. The two permeable structures 106 can be connected by welding or adhering through an adhesive layer 110. Referring to FIG. 3B, the magnetic component 300b can be formed by covering the coil 302, which has a non-uniform thickness, with a permeable material. Then, the permeable material is pressed, hardened, sintered or solidified so as to form the permeable structure 304. Thus, the magnetic component 300b can be manufactured.

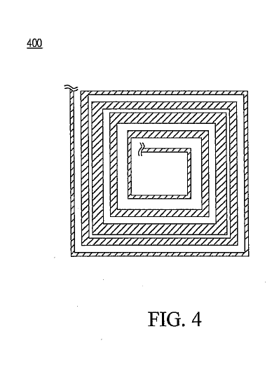

In addition, the shape of the coil in the magnetic component of the present invention is not limited to the above-mentioned illustrations. For example, it can be the coil 400 as shown in FIG. 4. In the coil 400, which is formed by a radially wound wire, the gap between adjacent two inner circles of the wire and the gap between adjacent two outer circles of the wire are different from the gap between middle portions of the wire. For example, the gap between adjacent two inner circles of the wire and the gap between adjacent two outer circles of the wire can be greater or smaller than the gap between middle portions of the wire. In other words, the gap of the adjacent circles of the wire is gradually increased and then gradually decreased from the inner circle to the outer circle of the wire, or is gradually decreased and then gradually increased from the inner circle to the outer circle of the wire. In the above-mentioned various aspects, the adjacent gaps between the adjacent circles of the wire can be the same or different.

As mentioned above, when the gaps between adjacent two inner circles and adjacent two outer circles of the wire is greater than the gap between the middle portions of the wire, the alternating current loss can be decreased. Thus, the quality factor can be improved and the performance of the magnetic component can be enhanced.

In addition, in the coil 400, the width of the inner circle of the wire and the width of the outer circle of the wire can be different from the width of the middle portion of the wire. For example, the widths of the inner and outer circles of the wire can be greater or smaller than the width of the middle portion of the wire. In other words, the width of the wire is gradually increased and then gradually decreased from the inner circle to the outer circle of the wire, or is gradually decreased and then gradually increased from the inner circle to the outer circle of the wire. In the above-mentioned various aspects, the widths of adjacent circles of the wire can be the same or different.

As mentioned above, when the widths of the inner circle and the outer circle of the wire is smaller than the width of the middle portion of the wire, the alternating current loss can be decreased. Thus, the quality factor can be improved and the performance of the magnetic component can be enhanced.

In the above-mentioned aspects of various widths and/or various gaps, the thickness of the coil 400 can be uniform or various as the previously mentioned coil 102, 202a, 202b, 202c or other examples. The material of the coil 400 is the same as the above-mentioned coil 102, 202a, 202b and 202c, so the detailed descriptions thereof will be omitted.

Moreover, the coil of the present invention can be formed by a radially wound wire, which includes a plurality of circles. Every circle of the wire can have the uniform thickness or width. The thicknesses, widths and gaps of the adjacent circles of the wire can have the various aspects as described hereinabove.

Furthermore, in the magnetic component of the present invention, the above-mentioned various aspects of the thickness, width and gap of the wire can be combined depending on the actual need so as to obtain the desired effect.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A magnetic component comprising:
at least one coil formed by a radially wound wire, wherein a thickness of an inner circle of the wire is different from a thickness of an outer circle of the wire; and
a permeable structure covering the coil.

2. The magnetic component according to claim 1, wherein the thicknesses of the inner circle and the outer circle of the wire are different from that of a middle portion of the wire, or the thickness of the wire is various depending on the distance from a portion of the wire to a center axis of the coil.

3. The magnetic component according to claim 1, wherein widths of the inner circle and the outer circle of the wire are different from that of a middle portion of the wire.

4. The magnetic component according to claim 1, wherein a gap between adjacent two inner circles of the wire and a gap between adjacent two outer circles of the wire are different from a gap between middle portions of the wire.

5. A magnetic component comprising:
at least one coil formed by a radially wound wire, wherein at least two circles of the wire of the coil have different thicknesses or widths, or at least two gaps between adjacent two circles of the wire of the coil have different distances; and
a permeable structure covering the coil.

6. The magnetic component according to claim 5, wherein a thickness of an inner circle of the wire near a center axis of the coil and a thickness of an outer circle of the wire are different from a thickness of a middle portion of the wire.

7. The magnetic component according to claim 5, wherein a width of an inner circle of the wire near a center axis of the coil and a width of an outer circle of the wire are different from a width of a middle portion of the wire.

8. The magnetic component according to claim 7, wherein a thicknesses of the inner circle and the outer circle of the wire are different from a thickness of the middle portion of the wire, or the thickness of the wire is various depending on the distance from a portion of the wire to the center axis of the coil.

9. The magnetic component according to claim 7, wherein a gap between adjacent two inner circles of the wire and a gap between adjacent two outer circles of the wire are different from a gap between the middle portions of the wire.

10. The magnetic component according to claim 5, wherein a gap between adjacent two inner circles of the wire and a gap between adjacent two outer circles of the wire are different from a gap between middle portions of the wire.

11. The magnetic component according to claim 10, wherein thicknesses of the inner circle and the outer circle of the wire are different from that of the middle portion of the wire, or the thickness of the wire is various depending on the distance from a portion of the wire to a center axis of the coil.

12. The magnetic component according to claim 5, wherein the thickness of the wire is gradually increased or decreased from the inner circle to the outer circle of the wire, and the thicknesses or the widths of adjacent circles of the wire are the same or various.

13. The magnetic component according to claim 5, wherein the thickness of the wire is gradually increased and then gradually decreased from the inner circle to the outer circle of the wire, or is gradually decreased and then gradually increased from the inner circle to the outer circle of the wire.

14. The magnetic component according to claim 5, wherein the width of the wire is gradually increased and then gradually decreased from the inner circle to the outer circle of the wire, or is gradually decreased and then gradually increased from the inner circle to the outer circle of the wire.

15. The magnetic component according to claim 5, wherein the gap of the adjacent circles of the wire is gradually increased and then gradually decreased from the inner circle to the outer circle of the wire, or is gradually decreased and then gradually increased from the inner circle to the outer circle of the wire.

16. The magnetic component according to claim 5, wherein the gap of the adjacent circles of the wire is the same as or different from another gap of additional adjacent circles.

17. The magnetic component according to claim 5, wherein the permeable structure comprises Ni—Zn ferrite, Mn—Zn ferrite or a polymer comprising a magnetic material.

18. The magnetic component according to claim 5, wherein the coil is directly disposed in the permeable structure or a permeable material, or is formed as a metal layer disposed on the permeable structure having a pattern corresponding to the coil.

19. The magnetic component according to claim 5, wherein the permeable structure comprises a first permeable body and a second permeable body, an adhesive layer is disposed between the first permeable body and the second permeable body, and the adhesive layer comprises epoxy, polyamide or an adhesive material containing magnetic particles.

20. The magnetic component according to claim 5, wherein the permeable structure comprises a first permeable body and a second permeable body connected with each other by welding or adhering, or the permeable structure is formed by pre-sintering the first permeable body and the second permeable body, adhering the first permeable body and the second permeable body, and then sintering the first permeable body and the second permeable body again.

21. The magnetic component according to claim 5, further comprising at least one insulating layer formed between adjacent two circles of the coil.

22. The magnetic component according to claim 5, wherein the thickness or width of one of the circles of the coil is uniform.

23. The magnetic component according to claim 5, being an inductor, a transformer, a common mode noise filter or a differential mode noise filter, or being applied to a DC/DC converter or a radio frequency (RF) module.
